(19) United States
(12) Patent Application Publication
(10) Pub. No.: US 2012/0226575 A1
(43) Pub. Date: Sep. 6, 2012

(54) ELECTRONIC TICKET MARKET

(76) Inventors: Brett Ian Goldberg, New York, NY (US); Christopher O'Brien, Massapequa, NJ (US)

(21) Appl. No.: 13/405,251

(22) Filed: Feb. 25, 2012

Related U.S. Application Data
(60) Provisional application No. 61/449,048, filed on Mar. 3, 2011.

(51) Int. Cl. G06Q 30/08

(52) U.S. Cl. 705/26.3

(57) ABSTRACT

A method is provided. The method comprises obtaining data identifying a buyer of tickets for a venue and obtaining data from the ticket buyer identifying at least one section within the venue. The method obtains data identifying (i) a maximum amount the ticket buyer would spend for a first ticket associated with a most favorable seat within the section; and optionally (ii) a maximum amount the ticket buyer would spend for a second ticket associated with the least favorable seat. The method then provides an algorithm that receives the data that the ticket buyer identified. The algorithm generates a plurality hypothetical acceptable tickets representative of the ticket buyer. The method then generates a matrix comprising of the ticket buyer's bids and extrapolated hypothetical bids to give other ticket buyers and tickets sellers' feedback to adjust bids and asks or provides the sellers the ability to execute a transaction.

### CROSS REFERENCE TO RELATED PATENT APPLICATIONS

The instant patent application claims priority to U.S. Provisional Patent Application Ser. No.: 61/449,048 to Goldberg et al. filed on Mar. 3, 2011, which is herein incorporated by reference in its entirety.

### FIELD OF THE INVENTION

The present disclosure is directed to a computer system for a secondary electronic ticket market. More particularly, the present disclosure is directed to an online system that permits sellers and buyers to view data corresponding to the bid or the ask value of the tickets based on venue, price and demand and to allow an individual to mark the tickets to market value.

### BACKGROUND OF THE RELATED ART

U.S. Pat. No. 7,383,206 B2 to Rupp et al., is assigned on its face to ARIBA, INC. of Sunnyvale California (hereinafter “Rupp”) and which is incorporated by reference in its entirety. Rupp was filed on Mar. 31, 1999. Rupp is directed to an online auction. The online auction includes several parties including a sponsor, an auction coordinator and a number of bidders. The bidders may make “multi-variable bidding” in which a bidder can change the price of the bid based on certain conditions.

The method includes receiving initial values for each bid variable. The method then calculates an initial total bid value by performing the function on the bid variables using the initial values. The method then receives an updated value for one of the bid variables and automatically calculates an adjusted value for the total bid value by performing the function using the updated value without any additional input. See Col. 3, lines 25-50. The online electronic auction may sell products or services. See Col. 4, line 60. The auction may have multiple buyers and sellers. See Col. 5, lines 40-50. As shown in FIG. 1B, during the auction, the sponsor 10 can typically monitor the bidding as it occurs. Bidders 30 may also be given some feedback on the auction activity so that they may bid competitively.

Feedback about bidding activity is generally referred to as “market feedback” and may include any information or data related to the bidders 30 or their bids, interrelationships between bids, and any other bid related information or data that is received before or during the auction. See Col. 6, lines 19-48.

Market feedback may include, for example, bids that have been placed by other bidders, the rank of a bidder's bid in relation to one or more other bidders, the identity of bidders, or any subset of that information. Market feedback may also include non-pricing information such as, for example, the quality of goods to be provided by bidders and shipping costs associated with one or more bidders. Providing such market feedback to bidders in an auction helps create real-time competitive interaction among bidders in the auction because, without feedback, bidders who are not leading in an auction might not be aware of their relative position and have less incentive to revise price quotes and place additional competitive bids.

After the auction, the auction coordinator may analyze the auction results with the sponsor. In a supplier-bidding auction, the sponsor typically conducts final qualification of the low bidding supplier(s). The sponsor may retain the right not to award business to a low bidding supplier based on final qualification or other business concerns. As shown in FIG. 1C, at least one supply contract is usually drawn up and executed based on the results of the auction. At col. 11, line 53-59, a user interface is provided that allows a user to adjust the value of the bid variables. In one embodiment disclosed at Col. 10, lines 63-65, the bidder can see other bidders' summarized comparative bids as market feedback.

U.S. Pat. No. 6,564,192 B1 to Kinney, Jr. et al. is assigned on its face to FreeMarkets, Inc. of Pittsburgh, Pa. and was filed on Jun. 8, 1999 hereinafter “Kinney” and which is incorporated by reference in its entirety Kinney discloses a system for differential index bidding in an online auction. The online auction may include buyers and sellers. The buyers and sellers may engage in an electronic bidding process for items. Buyers and sellers may engage in price quotes and length of contract Kinney increases the competitive dimensions upon which an auction is run by enabling suppliers to compete over the length of the contract, not just the initial fixed price.

Competition over the length of the contract is enabled through a bidding process that is performed relative to a predefined cost or price index. The index or combination of indices are specified prior to the auction and communicated to all bidders. During the auction, bids are stated in terms that are relative to the current and future values of this index. Bids can be a percentage or absolute differential relative to the index, depending on the needs of the particular market. In addition, bids can be positive, zero or negative depending on whether bidders wish to bid above (premium), at, or below (discount) the nominated index. The bidding process can be run against any arbitrarily defined index that can be calculated at points in the future. The index is time-varying and can be based upon one or more industry published indexes. Alternatively, the index can be based upon a formula that is defined by an industry or by the originator of the auction. See Col. 4, lines 9-54.

The bidding process is shown in FIG. 5, the process may include a broadcast function where real time competition between supplies is achieved whereby suppliers can view the activities of the competition and plan a strategy. The ability to see a competitor's bids then stimulates the opportunity to lower price, or discount. See Col. 8, line 48-55.

The “Index Bidding” online auction format allows an online real-time interactive auction to take place where bidders are competing by submitting bids relative to a reference point established by the buyer. The reference point may be a third-party industry index or a reference price (or schedule of prices) set by the buyer. All bids are relative to this reference point, permitting apples-to-apples comparison of all bids. For example, bidders may bid a percentage discount/premium against the reference point (e.g. 3% discount), or a difference in absolute value from the reference point (e.g. $0.30 per pound discount). Bids can be defined via a price schedule and can be used for a published list or catalog of items. The method can separately specify the form of a bidder's bid and the display of that bid. Bids can be accepted for only the amount representing the differential, or may be accepted as the differential added to a starting value of the index. Further, bids can be displayed as differentials or as “gross” including a starting value of the index.

U.S. Pat. No. 7,797,220 to McIntyre is unassigned on its face and was filed on Apr. 21, 2000 hereinafter “McIntyre” and which is incorporated by reference in its entirety. McIntyre discloses a range bid model for an electronic auction. The electronic auction has a potential seller that uses a computing device to request a price range bid, e.g., a lower limit, expiration date, quantity, quality and other relevant parameters corresponding to the selling product or service.

The central server system then looks for a range bid overlap with a potential buyer (step S4), and if an overlap is found (YES in step S5); the central controller or server system divides or splits the overlap region to arrive at a price point (step S6). Subsequently, a tracking number is added, and the transaction becomes binding (step S7). Funds received from the buyer's account are placed in the seller's account (step S8), and the transaction status is changed to “COMPLETED” (step S9). In step S10, a purchase confirmation is transmitted to the buyer, preferably by email or the like. In the event that the central controller does not find an overlap between the seller's bid range and the buyer's bid range (NO in step S5), both a buyer and seller can be notified and requested to make adjustments to the respective bids.

An example of the range bid model is described with reference to FIGS. 5 and 6. The buyer submits an upper limit bid of $300.00, and the seller submits a lower limit bid of $250.00, resulting in a $50.00 overlap region. The server controller system divides the overlap region evenly and sets a price point of $275.00. As a result, both the buyer and seller leave the transaction with a price better than what they were willing to accept.

If the buyer upper limit is, for example, $250.00, and the seller lower limit is, for example, $300.00, a $50.00 shortage region exists. In this instance, the buyer and seller may be asked to adjust their bids accordingly or terminate the transaction. Alternatively, if both the buyer and seller agree, the shortage region can be displayed to each party along with a proposed theoretical price point, midway between the buyer upper limit and the seller lower limit ($275.00 in the example of FIG. 6).

A range of ranges can be selected to allow the model to run over time. The range of ranges allows a bidder and/or seller to automatically change a price range by a certain amount per unit of time. As a seller, for example, one party may instruct the model to reduce the minimum by a certain amount of each of several periods of time (e.g., $10.00 every 12 hours) until a match is made or until the product is no longer available. This “range of ranges” concept is allowed as a convenience to either party, recognizing that supply and demand market forces are constantly changing.

U.S. Published Patent Application No. 2010/0262510 A1 to Schwarz et al. is unassigned on its face (hereinafter “Schwarz”) and which is incorporated by reference in its entirety. Schwarz is directed to the online electronic auction of Google® Adwords® or an Internet Search Provider's internet keywords. The online electronic auction can create and store a plurality of mappings of bid times quality score (BQS) distributions to value times quality score (VQS) distributions.

As FIG. 4 illustrates, in a particular implementation, server host 120 initiates process 400 which begins by determining one or more of VQS distributions (402). A VQS distribution may comprise the mean, or average, of one or more VQS values and the standard deviation of one or more VQS values. The value may be an amount, or price, an advertiser is willing to pay the search engine provider for a particular ad placement in the result set of a query related to a particular keyword.

A quality score (QS) may be a value assigned by the search engine comprising a click-through rate (CTR) for a given position in the result set, the relevance of the content of the advertiser's web site to the keywords sold, the overall quality of the advertiser's web site, and/or other factors.

Process 400 continues (404) by determining an optimal minimum reserve price oMRP for each VQS distribution derived in step 402. Optimal minimum reserve price oMRP is a minimum amount an advertiser may bid for a particular keyword. The procedure for determining optimal minimum reserve price oMRP from a VQS distribution is discussed in detail below with reference to FIG. 6.

The set of VQS distributions and matching optimal minimum reserve prices oMRPs may be stored (406) to system memory 214 and/or mass storage 218 device. In a particular implementation, the VQS distributions and matching optimal minimum reserve prices oMRPs are stored in mapping data structure 414 on mass storage device 218.

In a particular implementation, a number of simulated auctions are performed (408) using VQS distributions determined in step 402 and optimal minimum reserve prices oMRPs determined in step 404. Each simulated auction may result in calculating one or more BQS values. The one or more BQS values may be used to create a BQS distribution (410) for each VQS distribution determined in step 402. In a particular implementation, the results may be stored in mapping data structure 414. See paragraphs 53-55.

FIG. 8 illustrates an example process 800 that can be implemented by server host 120 to determine the final minimum reserve price fMRP for an auction. In a particular implementation, process 800 begins by searching bid history table 514 for a particular keyword (802). A predetermined time span t may be used to limit the search of bid history table 514. For example, time span t may represent one day, one week, or some other time span. Process 800 continues by computing the historical mean, or average, bid amount, standard deviation of the bid amounts hsb, and the mean, or average, number of bidders hmnb for the data returned by the search in step 804. Then, the method determines a current minimum reserve price (806).

In one implementation, the current minimum reserve price cMRP is the result of the previous iteration of setting a minimum reserve price related to the keyword. Initially, the first instance of the minimum reserve price for a given keyword, prior to executing an instance of the method described herein, may be set to a default value or determined by another process.

If the lowest bid amount hmb, is higher than the current minimum reserve price cMRP by some predetermined range, then additional bids may be implied. In a particular implementation, implied bids may be generated by one or more methods such as a random or linear distribution of bids between the lowest bid amount hmb and the current minimum reserve price cMRP.

U.S. Pat. No. 6,536,935 discloses a computerized system for market-based constraint optimization and which is incorporated by reference in its entirety. The system includes at least two agents that communicate via a protocol and that include one or more rules to constrain a variable.

U.S. Published Patent Application No. 2009/0012906A1, which is incorporated by reference in its entirety, discloses an online auction system whereby a user can offer an item for sale and then withdraw the offer based on a better second offer.

U.S. Published Patent Application No. 2004/0133526A1, which is incorporated by reference in its entirety, discloses a pricing parameter being determined from at least two electronic offers.

U.S. Pat. No. 7,627,514 to Guler, which is incorporated by reference in its entirety, is assigned to Hewlett-Packard®. Guler discloses an electronic online auction that takes into account statistical information from prior bidding. See Col. 2, line 44.

### SUMMARY OF THE INVENTION

None of the above references disclose or suggest problems experienced with an electronic ticket market. Generally, a ticket buyer and ticket seller can list tickets on a website. Alternatively, in a primary market a buyer can purchase tickets to a venue via an intermediary. The present disclosure can encompass a primary, secondary ticket market. Generally, a ticket buyer can view tickets for sale. A ticket seller lists tickets that the ticket seller owns at a low, fair value or a marked up rate. However, there may be a huge spread or difference between the amount the ticket seller wants to receive and the amount the ticket buyer wishes to pay. In an auction type model, there are a number of bids that can drive the price, however in a ticket market site model, there is no such driver.

This difference can be attributed to many variables such as venue, the event, the date, alternate dates, the weather, demand, supply, market conditions, liquidity, and many other variables, such as seat location. Currently, there is no function where a ticket seller can receive feedback as to the amount the ticket seller is asking is either too high or too low. For example, on EBay, if a seller posts tickets for sale, there is an option that allows them to accept reverse inquiries, therefore a user, can respond. A seller who is trying to sell their tickets for $100, can have a potential buyer propose a specific bid at a different price, such as $50.

The present invention remedies these problems and assists both the ticket buyer and the ticket seller with finding the true value of the item for sale.

It is an object of the present invention to provide a system where a ticket seller can view electronically a number of hypothetical prices levels where a ticket buyer would feel comfortable at purchasing a ticket. In one embodiment, the system may or may not allow sellers/users to see all of the other bids behind the highest bid per a seat. In another embodiment, these bids placed by buyers are firm bids and to place bids, users will have to create an account with a credit card on file. In yet another embodiment, the system may allow a buyer and a seller view a number of bids to determine whether the bids are reliable based on volume.

It is also an object of the present invention to provide a system where a ticket buyer can input an amount that the ticket buyer would offer for a predetermined seat and then the system extrapolates a number of hypothetical price levels where a ticket buyer would feel comfortable at purchasing a ticket for other seats and then displays the data in a graphical table for the benefit of a potential ticket seller. In one embodiment, the hypothetical price levels can be considered firm bids. In another embodiment, the hypothetical price levels can be considered firm bids after additional information is provided.

It is also an object of the present invention to provide a system that permits a ticket seller to list an item at a first price point and then view a number of hypothetical price levels and then potentially adjust the first price point upwardly or downwardly to correlate with the hypothetical price levels.

It also is a further object of the present invention to provide a system where (1) a ticket buyer can input an amount that the ticket buyer would offer for a predetermined seat and then (2) the system extrapolates a number of hypothetical prices levels where a ticket buyer would feel comfortable at purchasing a ticket for other seats and then (3) the system displays the data in a graphical table for the benefit of a potential ticket seller and then (4) the ticket seller accepts one of the hypothetical price levels and then (5) an offer is presented to the ticket buyer for the ticket seller's ticket for acceptance.

It is also an object of the present invention to provide a system that can permit ticket sellers to mark their tickets to market value based on information gathered from actual ticket buyers.

According to a first aspect of the present disclosure, there is provided a method comprising: obtaining data identifying a buyer of tickets for a venue and obtaining data from the ticket buyer identifying at least one section within the venue. The method obtains data identifying (i) a maximum amount the ticket buyer would spend for a first ticket associated with a most favorable seat within the section; and optionally (ii) a maximum amount the ticket buyer would spend for a second ticket associated with the least favorable seat with the same section. In another embodiment, the system can only receive one data point and the system may extrapolate a number of price levels that can turn into firm bids.

The method then provides an algorithm that receives the data of (i) the maximum amount the ticket buyer would spend for the first ticket associated with the most favorable seat within the section; and (ii) the maximum amount the ticket buyer would spend for the second ticket associated with the least favorable seat in the section. In another embodiment, the technology can also be used so a user chooses one section, but only wants to bid on a subset of the rows in that section, i.e. a user only want to bid on rows A-D, although the section has rows A-K.

The algorithm generates a plurality hypothetical acceptable tickets representative of the ticket buyer or a hypothetical ticket value, for the extrapolated seats that the user is comfortable paying for. The hypothetical acceptable tickets may be for tickets in the same section with a gradient of price levels per seat and potentially tickets in sections that were not selected but that are within a relevant or similar price range to the bids placed by the user.

The method then generates a matrix comprising at least one of the ticket buyer's bids and extrapolated hypothetical bids. Other ticket buyers and ticket sellers can receive feedback to adjust bids and asks from this information. For example, the ticket seller can view a hypothetical price level for a seat in a section as compared to an extrapolated price level based on the algorithm and then adjust or modify the amount of the ask for the seat. In another embodiment, the method may recommend an amount of the ask price for the seat.

In one embodiment, the method may extrapolate and suggest a price bid from a number of users. In another embodiment, the method may calculate a hypothetical bid based on an algorithm and a price gradient from other data. For example, the system may gather data that ticket seats are selling for four times face value and the system may recommend a hypothetical bid that is four times face value for different seats. In another embodiment, the method may form a gradient of prices from the data input by the user and for example may include a first data point of a first seat and a second data point of a second seat and then may extrapolate a number of prices between the first and the second seats to form a so called price gradient and calculate a hypothetical price value for a number of seats formed from the gradient.

In yet another aspect of the present disclosure there is provided a system. The system has a first computer system comprising a processor, a memory, a bus and an internet connection. The first computing system is accessed by a first entity. The system also has a second computer system comprising a processor, a memory, a bus, and an internet connection.

The second computing system is accessed by a second entity. The system obtains data identifying the first entity. The first entity represents a first commercial transaction participant.

The system obtains data identifying an amount the first entity would be willing to bid for a commercial transaction. The system, using an algorithm, generates a plurality of hypothetical acceptable bids for at least one seat or for different seats that the first entity would offer.

The hypothetical acceptable bids are generated by at least (i) the algorithm and (ii) the data identifying the amount the first entity would be willing to bid. The system generates a matrix regarding the bids and the plurality of hypothetical acceptable bids. The system permits the second entity to view the matrix.

In another embodiment of the present disclosure, there is provided a method comprising obtaining data identifying the first entity. The first entity represents a first commercial transaction participant. The method obtains data identifying an amount the first entity would be willing to bid for a commercial transaction.

The method uses an algorithm to generate a plurality of hypothetical acceptable bids that the first entity would offer. The hypothetical acceptable bids are generated in part by at least (i) the algorithm and (ii) the data identifying the amount the first entity would be willing to bid and (iii) bids from other users. The method then generates a matrix regarding the plurality of hypothetical acceptable bids. The matrix can then be inspected.

In another embodiment, the present disclosure includes a unique ticket recommendation system. The system is designed to help buyers select the most desired seats for the least amount of money. The system algorithmically sorts through all of the seller's available tickets and recommends the best deals. This is based on the asking price and the quality of the seat. More expensive tickets for lower quality seats may be ranked lower. Therefore, the best deal ranking system eliminates overpriced tickets and maximizes the buyers “bang for their buck”.

In a further embodiment, the present disclosure includes a functionality in that if two seats are being offered for the same price, yet they are in different locations, the seat with the better overall view (accounting for angle, location and proximity) will rank higher. Therefore, using the best deal ranking system the buyer will receive the best quality seat for the amount of money they are looking to spend. If there is a better quality seat for less money, the system's algorithms will recommend that a buyer buy the better quality seat for less money.

In yet another embodiment, the system may split a venue into a plurality of different zones. For example, the venues and arenas may be divided into three groups: Economy, Business and First Class. Groups are determined by proximity, location and user preferences.

In a further embodiment, personal seat preferences may differ from the zones. This sometimes occurs because the system may not sub-divide sections into different zones. However, using the “best deal” ranking system will minimize these discrepancies. This is because the Best Deal accounts for both the section and row when ranking the tickets.

In a further embodiment, the system may utilize using historical data, customer input and venue specific information (such as seat location, proximity and angle). The system may assign relative values for every row and seat. Each venue is done independent from one another. The best deal is then determined by comparing each ticket's price and the relative values to one another. For example, the front row in the center court at MSG would be considered 100%, while the row behind it, is 99%. Therefore on a relative value basis if these same seats were being offered at the same price the seat with the higher relative value would be ranked higher. However, if row A was being sold for $100 and row B for $95, then the row B ticket would rank higher. This is the case because the incremental dollar cost of $5 is more than the incremental increase in the seat quality of 1%. It is possible that user preferences may differ. However, no matter what, users will easily be able to view the best ticket options.

In a further embodiment, the system may include that the users that follow the best deal ranking system will pay the least amount of money possible for their desired seat location. If there are two different ticket listings that are for the same row, then the lower price ticket will have a better best deal rank. It is possible for the last row ticket to be the cheapest available ticket yet it may not be the best deal. This is because if there are better quality seats for the same or marginally less money, than the better quality seat would be recommended. Therefore, if row A has a relative value of 100% and row Z has a relative value of 40% we can compare which ticket(s) are a better deal by looking at the offering prices. Therefore, if Row A is selling for $100 and row Z is selling for $75, row A ticket may be considered a better deal.

In yet another embodiment, the system may not reveal the seat information for tickets. This is to protect a buyer's privacy as well as a seller's privacy when attending a show. Some sellers can choose to reveal seat numbers though it is not required and may be optional.

In a further embodiment, a buyer may make offers on section(s), groups of sections or zone(s) to increase chances to get the price a buyer wants. A buyer may make as many offers as desired. Once a seller confirms a sale bids will immediately become inactive.

In a further embodiment, by selecting desired sections and desired prices multiple times a user is given more control of the bids that are generated. A buyer may enter specific price points for specific section(s). For example a buyer may select sections 1, 2, and 3, and then may enter a price range of $80 to $100 and the bids that will be generated will all be between $80 and $100. This may generate a best bid of $100 and a worst bid of $95 for section 1. However, a user may not be interested in bidding $95 for the worst (furthest) seat in section 1. By entering more specific information a user can better control the bids that are generated. By only selecting section 1 the user may enter a price range of $85 to $100, which would result in a bid range of $85 to $100. It is not necessary to repeat these steps as bids generated and already determined by a price range, sections and selected and statistical data.

In another embodiment, a credit card is preauthorized when making an offer to ensure fairness to sellers but it is only charged when an offer is accepted.

In another embodiment, a buyer may choose to make an offer valid for a predetermined period of time, for example, 72 hours, or up until 3 days before the event.

In a further embodiment, a seller can accept an offer at any time it remains valid. If the timeframe expires and no seller has responded to an offer, it is automatically expires or lapses.

In yet another embodiment, if an offer is accepted, the tickets are guaranteed to arrive on time. A bidder can view bids in a dedicated webpage. A bidder may also change the bids as long as a sale has not already been confirmed.

In another embodiment, as part of a system guarantee to sellers, once the offer is accepted or the tickets are purchased, the bid cannot be changed or cancelled and an individual will receive an email as soon as an offer has been accepted letting a user know that a credit card has been charged and informing the user on when you can expect tickets.

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout different views. The drawings are not meant to limit the invention to particular mechanisms for carrying out the invention in practice, but rather, the drawings are illustrative of certain ways of performing the invention. Others will be readily apparent to those skilled in the art.

FIG. 1A is a schematic of a general purpose computer according to the present disclosure;

FIG. 1B is a screen shot of an online system showing a number of icons illustrating the method of the present invention;

FIG. 2 are screen shots of an online system showing a number of icons for the purchase of a ticket;

FIG. 3 is a screen shot of an online system showing data of a maximum amount a user would pay for the best and least favorable seats in a predetermined section;

FIGS. 4 and 5 show a user bid matrix and shows an online system of the user's bids as compared with a bid matrix to allow the ticket buyer to revise the user's bids;

FIG. 6 shows a screen shot of an online system of the user with an icon to revise the user's bids as per the matrix output;

FIGS. 6A and 6B show a seller's bid matrix viewpoint and the best bids in a format to allow a user to revise their bids;

FIG. 7 shows a number of method steps according to a method of the present disclosure commencing when the ticket buyer is logging in to the system of the present disclosure;

FIG. 8 shows a number of method steps according to the present disclosure commencing when the ticket seller is logged into the system;

FIG. 9 shows a number of hardware components according to the present disclosure;

FIG. 10 shows a method according to the present disclosure for splitting funds between a ticket buyer, a ticket seller and a software provider; and

FIG. 11 illustrates an embodiment method for displaying buy/sell bids and asks for seats on a per row basis to provide a more user functional graphical appearance.

### DETAILED DESCRIPTION OF THE PREFERRED EMBODIMENTS

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Reference will now be made in detail to the preferred embodiments of the present invention, examples of which are illustrated in the accompanying drawings. It is to be understood that the figures and description of the present invention included herein illustrate and describe elements that are of particular relevance to the present invention, while eliminating, for purposes of clarity, other elements found in typical systems and computer networks.

The present disclosure is directed to an online electronic system that includes a buyer of tickets, a seller of tickets, an online system and a venue that offers the number of tickets. The present disclosure is an interactive online secondary ticketing marketplace that allows both buyers and sellers to post and execute bids and offers within a framework that transforms individual bids into a dynamic and comprehensive pricing system. The system allows the buyers and the sellers more accurately mark down or mark up the sale prices or bids based on the features of the electronic system. Potential buyers place a bid for one or more seats for an event at a specific venue. Buyers will be offered to expand their bid to a range of seat locations at varying prices generated by a value per location utility algorithm. Buyers can accept or modify the proposed matrix pricing or reject the matrix and retain their specific seat bid. By merging the buyers various bids and parameters, the system will create a buyers' pricing gradient for the entire venue, in which buyers and sellers can view the highest bid for every seat. The pricing gradient will be dynamic, adjusting price levels as buyers modify their positions and sellers execute transactions. The pricing gradient is dynamic in the sense that if a user has the leading bid, for the highest bid for a seat, and they change their bid to be less, than the pricing gradient will change.

If the buyers new bid is still the highest, than the pricing gradient will now reflect that bid price, however it is possible that the users new bid is no longer the highest and the new highest bid (previously the second highest bid) placed by a different user will become the highest bid.

A pricing gradient may also change when a seller executes a sale. Multiple parameters can change the matrix in this case. In one embodiment, a bid which was the highest will no longer be there and now the second highest bid will be visible in the pricing gradient. It is possible that user A, the user who just bought ticket(s) had the leading bid on every seat in the venue. If this is the case, all of the users bids will no longer be part of the bid matrix, and all of the second highest bids will now represent the new pricing gradient. A pricing gradient is basically a slope or the like which is calculated between price point to extrapolate a hypothetical price level for seats that are located between the price points input by the user. However, this methodology is non-limiting and other methods may be used to calculate the hypothetical price. For example, the system may determine that price levels are at four hundred percent of ticket value on average. The system may calculate the hypothetical price to be in the range of four time ticket value. With the present disclosure, the seller's experience is enhanced by having the ability to see what current buyers are willing to pay for a specific seat to a specific event and also can view hypothetical price levels based on the actual ticket buyers' data which can be formed from bids, asks, or sales. Sellers can then post “ask orders” above the current bid matrix or execute a transaction at the posted bid level.

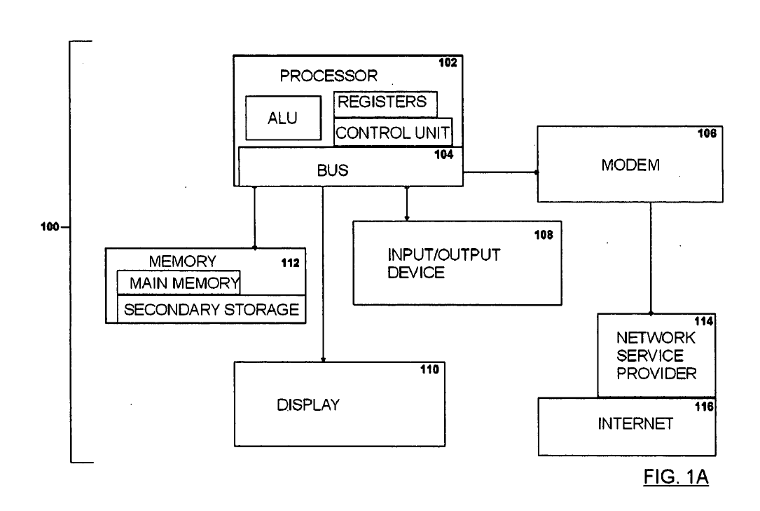

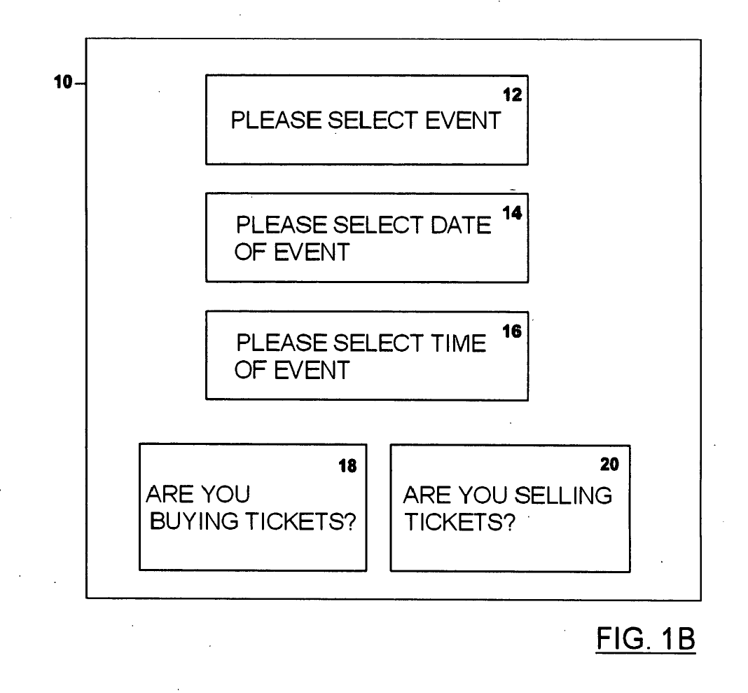

Turning now to FIG. 1A there is shown a general purpose computer to be used with the present invention generally shown as reference numeral 100. Turning now to FIG. 1A, there is shown a general purpose computer configuration that may be used with the present disclosure shown as reference numeral 100, which can be a mobile device, a desktop computer, a tablet computer, a laptop computer, etc. It should be appreciated that the present computer configuration 100 is a simplified diagram and shows only one non-limiting embodiment of the present disclosure. Various other computer configurations are possible and within the scope of the present disclosure (i.e., P2P, an array, a neural network and the like). It should be appreciated that the computer configuration 100 may include a multicore processor 102 that includes an arithmetic logic unit, registers, cache and a control unit as is known in the art. The processor 102 is connected to a bus 104 that provides control signals from the processor 102 to the various computer components shown in FIG. 1A. Bus 104 also receives signals and communicates the signals to the processor 102.

The computer 100 also includes a memory 112, which includes a main memory unit and secondary memory. Memory 112 is a recordable computer medium that stores program instructions and data and is operatively connected to the bus 104 and receives control signals from the processor 102. The bus 104 is also connected to a display 110 and an input device 108, such as a mouse, touch screen, trackball and/or a keyboard to permit a user to input data and to input control commands in a user functional manner.

Processor 102 preferably is not limited to a single central processing unit and may include multiple CPUs. For example, processor 102 may comprise two, four, five, eight or more processors working simultaneously in a parallel arrangement. In one non-limiting embodiment, the processor 102 may comprise several AMD® Phenom II 545® and 550® with 3.4 GHz processor speed. In a less preferable embodiment, the processor 102 may include an Intel® dual core®, i3®, i50, i7® or the Athlon® II processors 240®, 245®, 250® or similar processors. Bus 104 is further connected to a modem 106, which can be wireless or a wired modem that communicates with a network service provider 114. The network service provider 114 preferably connects with the Internet. Preferably, multiple ticket sellers or ticket buyers access a website as shown herein using a computer device like the computer device shown in FIG. 1A.

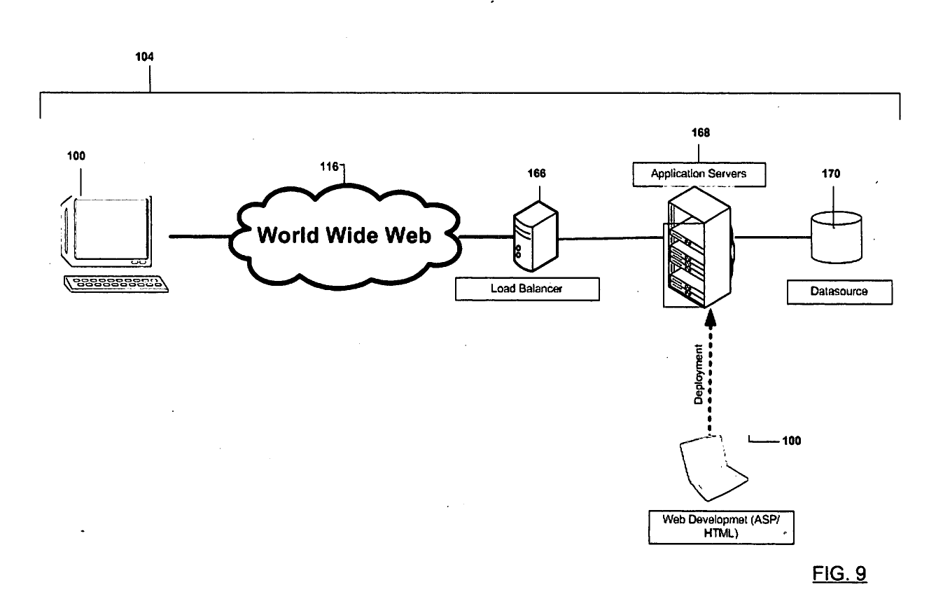

A computer software application is used to manage the secondary ticket market. The software application preferably has two components: a client component and a server component. FIG. 9 illustrates a server component and a client component resident in host computers in a first embodiment as shown in FIG. 1A. The server component has an operating system, communications software, and Internet protocol software. The server software is hosted on a computer similar to that of FIG. 1A having a processor 102, random access memory 112, and a data storage facility 112. The host computer also includes input and output devices such as, for example, a monitor, printer, mouse and keyboard, and a communications interface for communicating with the client component.

The client component includes communication software, and Internet protocol software stored on the memory 112. The client component software is hosted on a computer having a processor 102, random access memory 112, and a data storage facility. The host computer also includes input and output devices such as, for example, a monitor, printer, mouse and keyboard, and a communications interface for communicating with the server component.

In operation, a user will access the present system 10 using an internet web browser or the like and open a window. A web browser may include GOOGLE® CHROME®, MICROSOFT® INTERNET EXPLORER®, MOZILLA® FIREFOX®, OPERA®, APPLE® SAFARI® or the like. Turning now to FIG. 1B, there is shown a simplified graphical interface when a user logs into a potential website generally shown as reference number 10 and which is output on the display 110 shown in FIG. 1A. It should be appreciated that the icons and orientation of the website 10 is shown as one non-limiting embodiment and these details preferably form no limitations to the present disclosure. For example, the website may exchange different inputs and outputs via audible or any visual inputs/outputs known in the art. For example, in an alternative embodiment, a user may scan a ticket and the scanner may provide the inputs discussed herein. For example, in another embodiment, the user may input data using an APPLE® I-PHONE®, I-PAD®, I-POD® or GOOGLE® ANDROID® mobile communication device.

The user experience begins by selecting the specific event (sporting, musical, plays, and entertainment) they are interested. Generally, the graphical interface 10 is displayed on a screen 110 or the like via an Internet browser or mobile Internet browser. It should be appreciated that the client may select one or more icons using a mouse or touch screen, trackball or the like and provide inputs to the host. Parameters of the event may include: (1) an entertainer, (sports team or artist); (2) venue; and (3) a date.

Generally, the graphical interface may include a prompt or icon for an event generally shown as reference number 12. Icon 12 used herein is a graphic symbol (usually a simple picture, a button or text) that denotes a program or a command or a data file or a concept in a graphical user interface. Prompt 12 may include a drop down table populated by various events, such as concerts, music events, shows, plays, games, NASCAR® events, NFL® Football, MLB® baseball, NBA® basketball, NHL® hockey, college sports, professional sporting events, Broadway shows, or any other paper or electronic ticket based event. It should be appreciated that the tickets are issued by a third parties and issued to a ticket seller, which may sell the tickets to a ticket buyer as a secondary ticket market. However, alternatively, the present system may sell the ticket directly to ticket buyers from ticket providers and act as a primary ticket market.

Displayed also on the graphical interface 10 is a second prompt or icon directed to a date of the event generally shown as 14. The date may be the commencement of the event displayed in the icon 12. Displayed also on the prompt 16 is a time of the event.

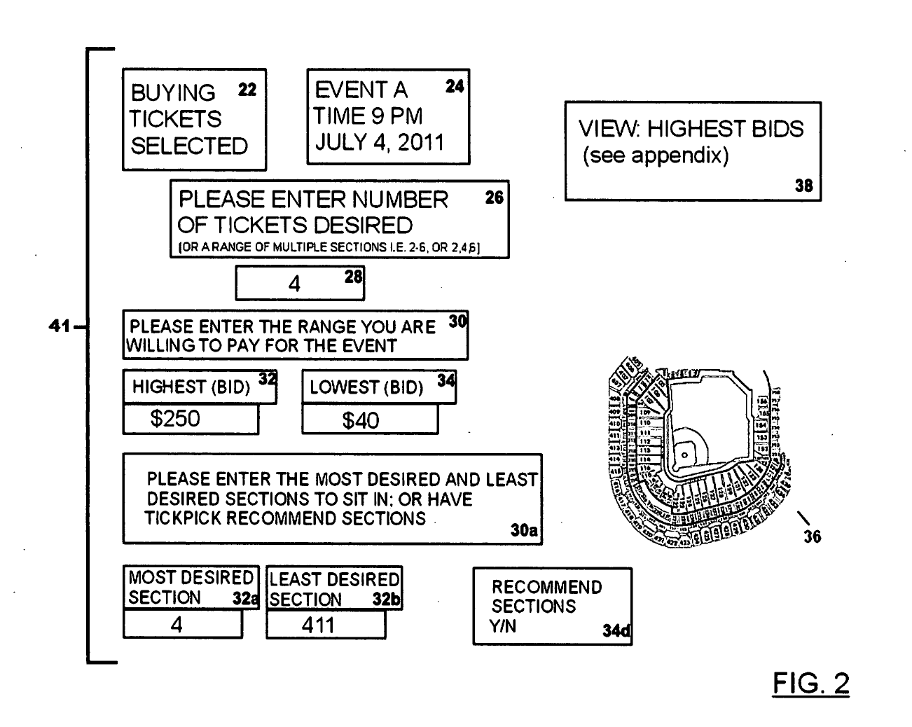

Disposed on the graphical interface 10 are also icons 18 and 20 directed to whether to identify the individual user as a buyer of tickets or a seller of tickets. Generally speaking in this particular embodiment directed to a secondary ticket market, and generally there are entities that have already purchased tickets from a ticket provider and that are wishing to resale the tickets to a different entity. Icons 18 and 20 preferably identify the individual user as a ticket buyer meaning an individual who is seeking to purchase a ticket using the graphical interface 10 or an individual who is looking to sell a ticket using the interface 10. In another alternative embodiment, the system 10 may include a third entity, which is a mere browser. The user may list as a ticket seller at one time and then may list as a ticket buyer at a second later time. The user will then be asked if they are interested in buying tickets (or selling tickets) at a price they dictate. After selecting buying tickets an indication is provided that this user is a ticket buyer as shown by icon 22 (FIG. 2).

Thereafter, the user will be guided through the graphical user interface shown in FIG. 2. An indication of the event also may be shown that includes the event name generally shown as event A (for example, NEW YORK YANKEES® TICKETS), and the time and date shown as icon 24. In one embodiment, the user may select a plurality of different dates and times or only one date in time. Various configurations are possible and within the scope of the present disclosure. Preferably, the graphical user interface 10 will display an icon 26 that indicates an amount of tickets that the ticket buyer is interested in purchasing in the secondary ticket market with a prompt 28. In this example, four tickets shown as reference 28 are selected as the data that the ticket buyer is interested in purchasing. In an alternative embodiment, there may be a limit on the number of units.

In another embodiment, the event can be a concert with similar attributes. Thereafter, the graphical user interface indicates a range of parameters that the user would pay for a seat at the event. These may include a prompt or icon for an amount that the user would be willing to pay for a seat as shown by reference numeral 30. The user will preferably input either an amount that the user would pay for a seat at icon 30 or alternatively the user can input the maximum amount that the user would pay for a seat at icon 32 or the highest bid, or alternatively the user will preferably input either the lowest amount that the user would pay for a seat at icon 34, or the lowest bid. These can be any two seats in the arena, in the same row, same section, etc.

In a second embodiment, the user can input at icon 30a the most desired and least desired sections to sit in (or have the system recommend sections based on your price range using icon 34d). At icon 32a and 32b, the user can input the most desired section and the least desired section where the user desires tickets, for example, Section 4 or Section 411. At icon 34a, the user can further select additional sections or delete sections to allow the instant system to gather data regarding the user. At icon 34b, the user can further select sections via the interactive seating chart or the area sections table shown as table 34c and graphic of the event location as reference numeral 36. The graphical user interface 10 then prompts the user to enter the maximum price they are willing to pay for the best seat in their selected section(s) shown as reference numeral with a prompt to enter the amount in dollars. Next, the graphical user interface prompts the user to enter the maximum price they are willing to pay for the least desirable seat in their selected section(s) with a prompt to enter the amount in dollars.

It should be appreciated that the “best seat in the selected section” is merely a subjective parameter that the user selects based on their ability to pay and choice and market conditions. Any user would desire the most expensive seat in the venue but many would be prohibited from purchasing this seat due to cost. However, a buyer has an idea of what they can afford and how much they can spend and which section they desire to sit. It should also be appreciated that the “least desirable seat in the section” also is a subjective parameter that the user selects based on their ability to pay and choice and market conditions. Generally, this would be a second seat within the same section that is of lesser value than the best seat in the section. In an alternative embodiment, the user may also use the icon of the stadium to provide the section as to the maximum price they are willing to pay for the best seat in the section or least desirable seat in the same section by selecting seats on the icon 36 representing the seats within the stadium, ballpark, or arena and keying in the amounts. These parameters are preferably inputs for which the online system can extrapolate other seats within the same section to provide data to other parties to give a picture of the market conditions.

The graphical user interface 10 may display an icon graphically simulating the arena or stadium illustrating a number of sections, rows or seats and the user may select the section, row and seat using the icon 36. It should be appreciated that many different venues may be stored in memory for display using the display 110. For example, Madison Square Garden®, CITIFIELD®, the Meadowlands®, Lincoln Financial Field®, Fenway Park®, etc. Through an interactive seating chart 36, the user may select via an input (or clicks using an input device) each section for each seat and the like. Alternatively, the user may use the keypad to enter in specific sections. In an alternative embodiment of the present disclosure, the user will also have the choice to click or enter broad seating groups, i.e. floor section, level etc.

The graphical user interface 10 will then prompt the user to be able to view a summary of the highest existing bids generally shown as reference numeral 38 (the initial summary will be for the broad seating groups). If a user is interested in more detail they have the ability to see existing bids by section or row or even by seat as shown by reference numeral 40. Regardless of the level of detail, the system preferably assists a user with evaluating a proper and competitive bid.

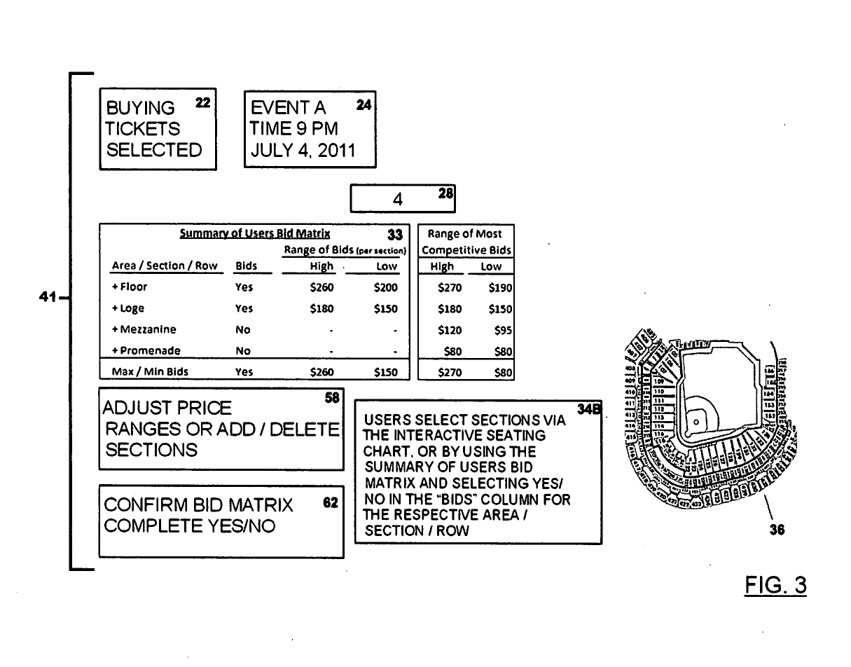

Turning now to FIG. 3, in the event the user chooses the system's recommendation, equivalent sections and or seats based on relative values and existing bids will be recommended. This will be done utilizing an algorithm and methodology as discussed herein.

As shown by reference numeral 41, the system outputs data regarding the best or most desirable section that the user has placed bids in, and the least desirable section, or as shown Section 4, Row A (most desired) and Section 411, Row Z (least desired) in FIG. 2. Icon 36 further is preferably highlighted with the sections that are recommended so the user can also be able to click on the map 36 to add or delete sections.

The graphical user interface 10 then prompts the user to enter the maximum price they are willing to pay for the best seat in their selected section(s) shown as reference numeral 46 with a prompt 50 to enter the amount in dollars. Next, the graphical user interface 10 prompts the user to enter the maximum price they are willing to pay for the least desirable seat in their selected section(s) as reference numeral 48 with a prompt 52 to enter the amount in dollars.

It should be appreciated that the “best seat in the selected section” is merely a subjective parameter that the user selects based on their ability to pay and choice and market conditions. In another embodiment, the system can solicit additional parameters and the system can provide relative values for each seat and the system could use these values to dictate what the best and worst seats are to assist the user. If a user disagrees they can change or overpower the relative value assumption when given the choice to accept the bid matrix. Any user would desire the most expensive seat in the venue but many would be prohibited from purchasing this seat due to cost. However, a buyer has an idea of what they can afford and how much they can spend and which section they desire to sit. It should also be appreciated that the “least desirable seat in the section” also is a subjective parameter that the user selects based on their ability to pay and choice and market conditions. Generally, this would be a second seat within the same section that is of lesser value than the best seat in the section. In an alternative embodiment, the user may also use the icon of the stadium to provide the section as to the maximum price they are willing to pay for the best seat in the section or least desirable seat in the same section by selecting seats on the icon 36 representing the seats within the stadium, ballpark, or arena and keying in the amounts. These parameters are preferably inputs for which the online system can extrapolate other seats within the same section to provide data to other parties to give a picture of the market conditions.

It should be appreciated that in FIG. 3 if the user chooses that the system is to provide a recommendation, then similar or equivalent sections (and or rows) will be recommended based on an algorithm utilizing the users bids, relative values and existing bids (same algorithm as discussed). As can be seen a summary of the bid is shown as a matrix 41 whereupon the specific location is shown (floor, lodge, seat, promenade) and a high and low price. The user may be permitted to amend the bids. Along side the matrix 41 is a number of data points illustrating high bids. This data can allow the user to revise their bids in order to remain competitive.

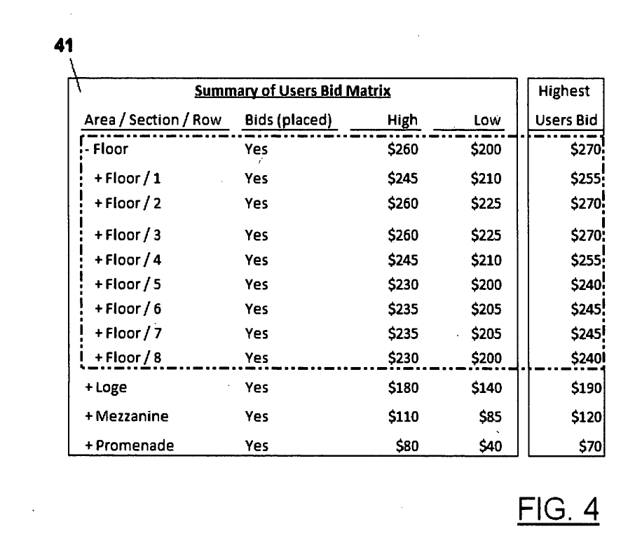

Turning now to FIG. 4 as can be seen the user can control the matrix 41 to drop down a level and see specific areas, sections, and rows. Matrix 41 provides the user's high and low bids per the relevant area (e.g. the section and row) and along-side this, is the highest existing users bids to help determine whether the high and low bids inputted (by the specific user) are competitive. The hypothetical data acts as an index where the system provides the user with a framework to determine if the user's bids are competitive and allows the user to revise the bids including the high low for the specific area.

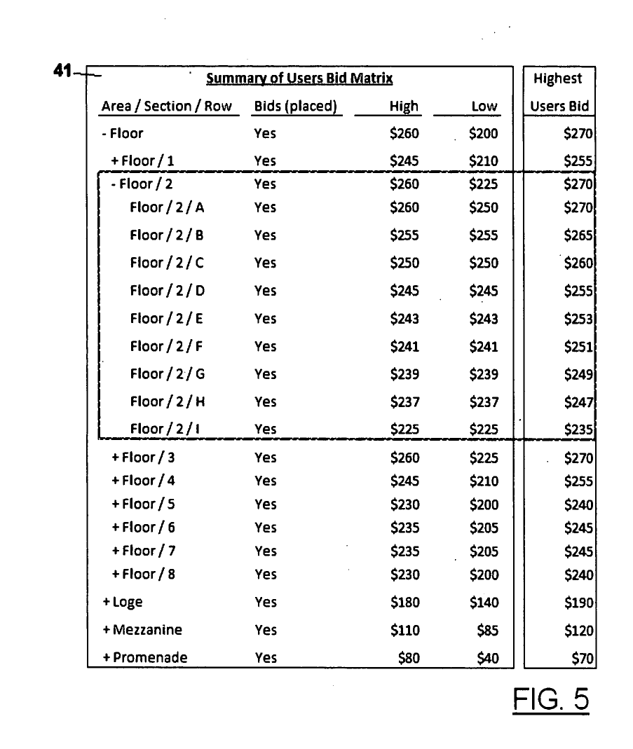

Turning now to FIG. 5, there is shown the matrix 41 where the user can drop down another level and now select within the specific area with increase granularity. As shown, the user can select the area, floor, section and row and place a high bid and a low bid for the particular tickets. Along side the matrix is shown the highest user bid. This again is a hypothetical bid that is extrapolated by the system or is calculated using a price gradient as discussed above or is a users bid. In this manner, the user will be given feedback as to whether the amount is competitive based on the specific area, floor, section and row, which is advantageous.

The graphical user interface 10 will prompt a user to place additional bids as while confirming the maximum amount for the best and least desirable seat in the section as shown. Although this is optional and not required, it will increase the accuracy of the bid matrix to better reflect the user's unique relative value. If the user chooses to place additional bids, the graphical user interface will revert and the user will select a section (with the ability to choose a specific row if desired) and place an additional bid. This can be done for as many sections and rows as the user wishes. In the event that the user desires not to make any more bids then the graphical user interfaces passes to the next step.

The system using a pricing algorithm, which is a mathematical function that assigns prices to specific seats based on bids placed and data provided to provide a bid matrix. Data may comprise relative values per a seat location, determined by proprietary and historical information.

Initial input from the user will determine one or many bids on specific seats in the venue. Using those price points, the algorithm will determine what prices the user is willing to pay for additional seats in the stadium (either user selects the seat range, or the system determines the seat range based on their min/max and existing users' bids). The algorithm will use two variables to generate these bids.

The first is the relative price value. Each seat in every venue will have a predetermined relative value based on proprietary and historical information. These values will provide a ratio of the relative value that can be used to extrapolate one bid on one seat into a suggested bid price on all seats throughout the stadium. For example, Seat value X/Seat Value Y=Bid on X/Suggested Price Y so that the seat values stored in a databases and the user's bid on seat X will determine the suggested price for seat Y.

The second is the distance. The distance provides the weighting mechanism for when multiple bids are given. This distance is calculated using a predetermined X and Y value for each seat in the stadium. Using this distance variable we can weight the bids so that a bid entered in section 101 will have more impact in the seats in section 101 than that of a bid placed in section 401. It should be appreciated that many different methodologies are possible and within the scope of the present disclosure.

A bid matrix 41 is created and the user has the option to accept it or modify the bidding matrix 41. The user will see a summary of their bid matrix as shown by reference numeral 41 compared to the summary of the highest existing bids. If the user has any bids that are leading bids (the highest bid) than that section or group will be highlighted and as can be seen the user includes one that is the same value.

A summary and a visual table shown in FIG. 5 and produced to assist the ticket buyer with determining if the current matrix 41 or any portion thereof will be accepted by a ticket seller. If a ticket buyer chooses to modify the matrix 41, the ticket buyer may select and input one or multiple new bids in the matrix 41. In an alternative embodiment, changing one bid can change the entire matrix 41. If any bid in the matrix 41 is modified, the bid matrix 41 will reflect the changes in real time as well as the summary output of the bid matrix 41. The ticket buyer using the graphical interface 10 can select icon and confirm the accuracy of the matrix 41 and accept the bid matrix 41.

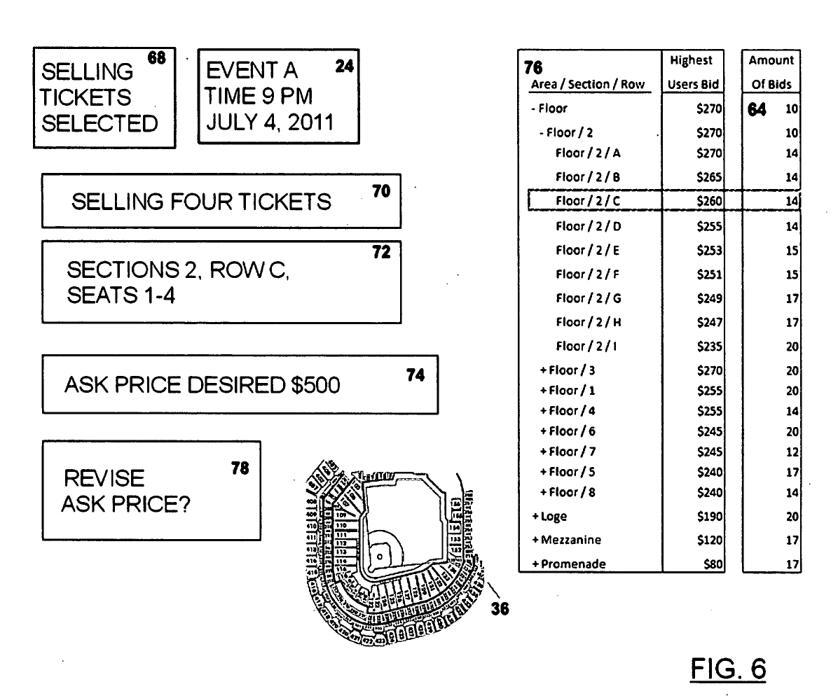

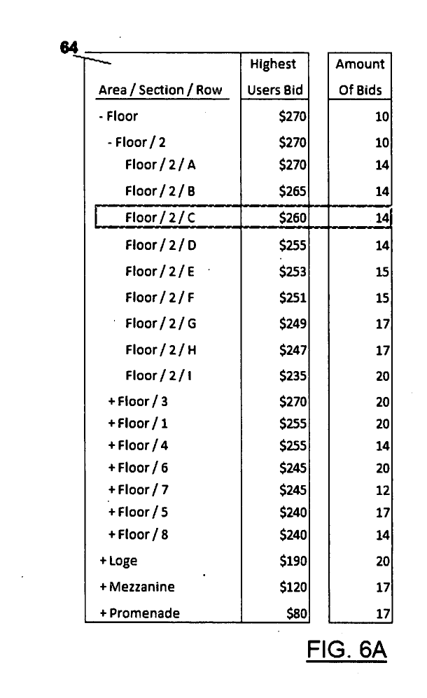

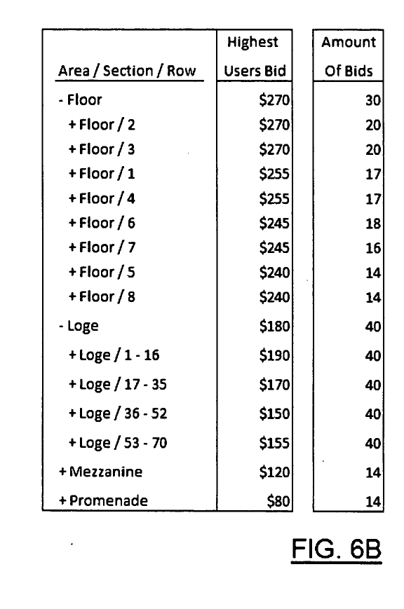

Turning now to FIG. 6, there is shown the graphical user interface 10 of a ticket seller on the other side of the transaction. Preferably, a ticket seller will login to the system 10 and access the system via a web browser or the like. The ticket seller has inputted the ticket information that the ticket seller owns by section, row and seats and ticket numbers as shown by icons 68, 70 and 72. The ticket seller has also input the ask price of the tickets as shown by reference numeral 74 of $500 per ticket.

Turning now to FIG. 6A, the ticket sellers may also view data the combined bid matrix 64 reflecting all current best bids in terms of best seat in the section and least desired seat in the section. As shown in FIG. 6A, the bids or best bids or average bids (whichever is displayed) preferably show a range for the same section by ticket buyers of $270 to $80 for comparable seats. Furthermore, for seats in a section, or Floor, Section 2, Seat C, the ticket buyers are bidding $260. Further, there are numerous bids for that particular amount (14 bids). Furthermore, the amount of the ask price of $500 of FIG. 6 appears to be a high ask value based on multiple variables including demand.

The ticket seller can further investigate and determine the reliability of these bids by displaying the amount of bidding or number of bids used to arrive at these displayed best bids as shown as matrix 64 in FIG. 6A. Since it appears that the ticket seller is asking a high amount, the ticket seller may then revise the ask price for the four tickets to arrive at a more reasonable level or withdraw the tickets. Thus, the tickets are marked to market.

In another embodiment, the ticket seller could have seen that the bidding matrix 64 indicates that the bids are higher than the ask price and the ticket seller may revise the ask price. This is essentially identical to the visual display and the summary of bids 41 that is used to help facilitate the ticket buyer in placing bids. The visual display of the venue will be interactive. The ticket seller can scroll over sections to see the maximum bids for the best and least desired seat. Additionally, by clicking the section the ticket seller can get a detailed summary of all the best or highest bids and best or highest asks in that section. To give users an idea of the depth of bids, the amount of total unique bidders (for the specific event) will be displayed. Additionally, the amount of bids placed on a section or row (depending on the details being viewed) will also be displayed in the visual venue and the summary.

In another embodiment, the user can or will have the option to allow the system to select the highest economic way to sell tickets. For example, the user may have four tickets to sell, and there is a user bidding for 2 (of the 4) tickets at $100 and two other individual bidders, bidding both $95. If the highest user that is bidding for all 4 tickets together is $90, then the user should sell the tickets to the user bidding for two tickets and the two other individual bidders. Various different formats can be made for the present disclosure and the matrix may be rendered in a different style or the like.

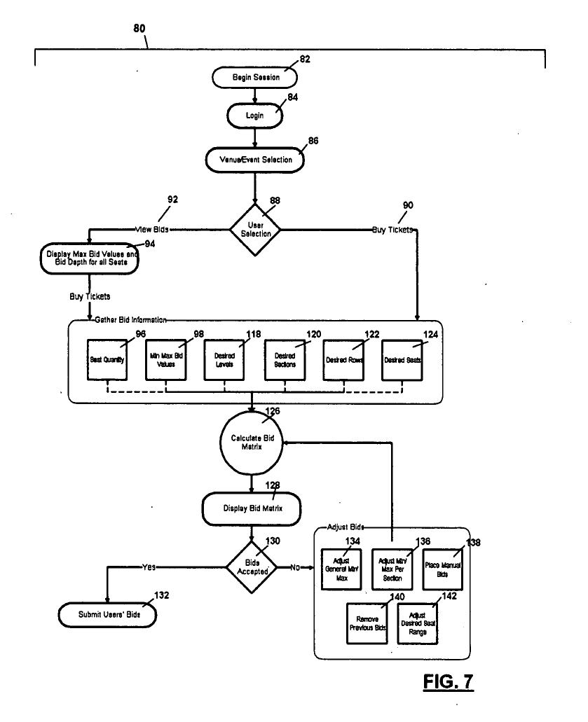

Turning now to FIG. 7, there is shown a software flowchart of a method according to the present disclosure. Preferably, the method 80 commences at step 82 where a session begins. The method 80 then passes to step 84. At step 84, the ticket buyer provides a login information including a unique email address, username and password. The login or logon is in computer security, a process by which individual accesses a computer system in a controlled manner using an identification of the user by using credentials provided by the user or provided by the host.

Once authenticated, the ticket buyer then is permitted access and control of the method 80 passes to step 86. At step 86, the ticket buyer provides a venue and event time, date, hour as shown above. For example, the venue can be input at the ROLLING STONES concert at MADISION SQUARE GARDEN on Jul. 4, 2011 at 9 pm. Thereafter, the method 80 passes from step 86 to step 88 where a decision is reached as to whether the user is an individual seeking to purchase tickets or an individual seeking to view bids of other parties to the event using the instant system. If at step 88, the ticket buyer selects to view bids then control of the method 80 passes along line 92 to step 94. If at step 88, the ticket buyer does not need to view any bids and wishes to simply purchase tickets, then control of the method 80 passes along line 90 to steps 96-124. Step 124 is optional and is not required but may be included.

At step 94, the ticket buyer can view the maximum bid values for predetermined seats and the bid depth of those seats. Once viewed, the ticket buyer can then pass from step 94 to steps 96 to 124. At steps 96-124, the bid data is aggregated. At step 96, a seat quantity data is gathered from the ticket buyer. At step 98, the maximum value for the most desired seat in a section is obtained and a maximum value for the least desired seat in the section is also obtained. At step 118, the desired level of the venue is gathered; at step 120, the desired section is gathered; at step 122 the desired row of the venue is gathered; and at step 124, the seat locations corresponding to the section and row are also gathered. Various configurations are possible and it should be appreciated that some data can be gathered like the section while leaving out the specific seat and row. In another embodiment, the section, row, seat all may be selected. Thereafter, once the data is gathered, then control of the method 80 passes to step 126.

At step 126, the bid matrix is created for the benefit of a ticket buyer and a ticket seller. The matrix comprises at least one of the instant ticket seller's bids and extrapolated hypothetical bids to give other ticket buyers and tickets sellers' feedback to adjust their bids and asks. The matrix may further provide reliability and error information. For example, an error, an indication that the bids include a statistically large number of bids, a statistically small number of bids, the mean bid, the median bid, the standard deviation, or any other statistically relevant information.

Thereafter, control passes from step 126 to step 128 to display the bid matrix to a ticket buyer or a ticket seller. Thereafter, control passes from step 128 to step 130 where a decisions is reached to permit the ticket buyer to accept the bid made in steps 96-124 or to revise the bids. If the decision at step 130 is affirmative, then control passes from step 130 to step 132 to submit the bid. If the decision at step 130 is negative (for example, the bids made have no chance of success since they are too high or too low), then control passes from step 130 to steps 134-142. At steps 134 and 136, the ticket buyer can cancel the previous bids and then enter and adjust the maximum value for the most desired seat in a section and adjust the maximum value for the least desired seat in the section. Thereafter, control of the method 80 passes to step 138, where a manual bid can be made or not made. Thereafter, control of the method 80 passes to step 140 where all bids can be removed or at step 142 an adjustment to the seat range, section range or row range can be made. Control then passes from step 142 back to step 126 where the matrix can be recalculated with the new data or updated. Thereafter, the method 80 ends.

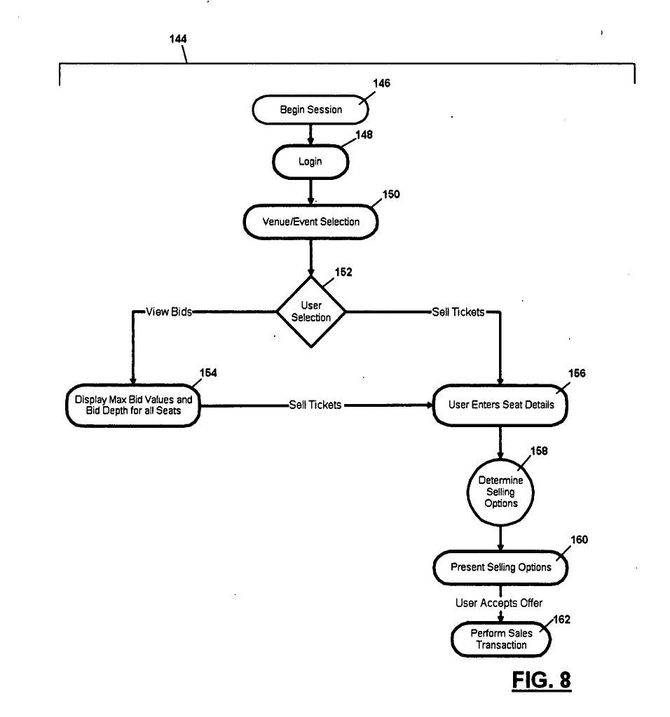

Turning now to FIG. 8, there is shown a software flowchart of a method 144 according to the present disclosure. Preferably, the method 144 commences at step 146 where a session begins. The method 144 then passes to step 148. At step 148, the ticket seller provides a login information including a unique email address, username and password. Once authenticated, the ticket seller then is permitted access and control of the method 144 passes to step 150. At step 150, the ticket buyer provides a venue and event time, date, hour as shown above. For example, the venue can be input as the ROLLING STONES® concert at MADISION SQUARE GARDEN® on Jul. 4, 2011 at 9 pm for the purposes of clarity with the ticket buyer of FIG. 7.

Thereafter, the method 144 passes from step 150 to step 152 where a decision is reached as to whether the user is an individual seeking to sell tickets or an individual seeking to view bids of other parties to the event using the instant system. If at step 152, the ticket seller selects to view bids then control of the method 144 passes to step 154. If at step 152, the ticket seller does not need to view any bids and the ticket seller wishes to simply sell tickets, then control of the method 144 passes to step 156.

At step 154, the ticket seller can view the matrix of bids and bid depth for all seats. The matrix comprises (i) ticket buyer's bids; (ii) ticket seller's asks, and (iii) extrapolated hypothetical bids and asks based on the actual bids and asks to give other tickets sellers and buyers feedback to adjust asks and bids. The matrix may further provide reliability and error information. For example, an error, an indication that the bids include a statistically large number of bids, a statistically small number of bids, the mean bid, the median bid, the standard deviation, or any other statistically relevant information.

Once the matrix is viewed, the tickets can be sold and then control passes from step 154 to 156. At step 156, the ticket seller can input the ticket seat details including number of tickets, ticket row, section, seats, electronic delivery, etc. Thereafter, control passes from step 156 to step 158 where selling options are determined for the ticket seller. At step 160, the present selling options are also determined and presented to the ticket buyer as a binding offer. A ticket buyer can then accept the offer and control passes to step 162 where a sales transaction can be performed and where funds and the tickets are exchanged and delivered either by conventional methods or via electronic delivery. For example, funds may be exchanged by a debit or credit provider, PAYPAL® or the like. The tickets may be exchanged via FEDERAL EXPRESS®, US MAIL, emailing an electronic PDF of the ticket or any other delivery method known in the art.

Turning now to FIG. 9, there is shown a computer system shown as reference numeral 164. The system 164 preferably includes a load balancer 166 operatively connected to a plurality of application servers 168. The application servers 168 are also connected to a data source 170, such as, for example, a memory array or number of memory components. Data source 170 is a recordable computer medium that stores program instructions and data. The methods discussed above can be stored on the data source 170. A first computing device 100 discussed above is connected to the internet 116, which is connected to the load balancer 166. Load balancer 166 is preferably operatively connected to the application servers 168, which respond to the requests made by the first computing device 100. A second computing device 100′ also accesses the internet 116, which is connected to the load balancer 166. The load balancer 166 preferably can be connected to the application servers 168. The servers 168 each preferably comprise a multi-core processor connected to a bus that provides control signals from the processor to the various computer components. Bus also receives signals and communicates the signals to the processor.

Data source 170 is operatively connected to the bus and receives control signals from the processor. The bus is also connected to a display and an input device, such as a mouse and a keyboard to permit a user to input data and to input control commands in a user functional manner. Processor preferably is not limited to a single central processing unit and may include multiple CPUs.

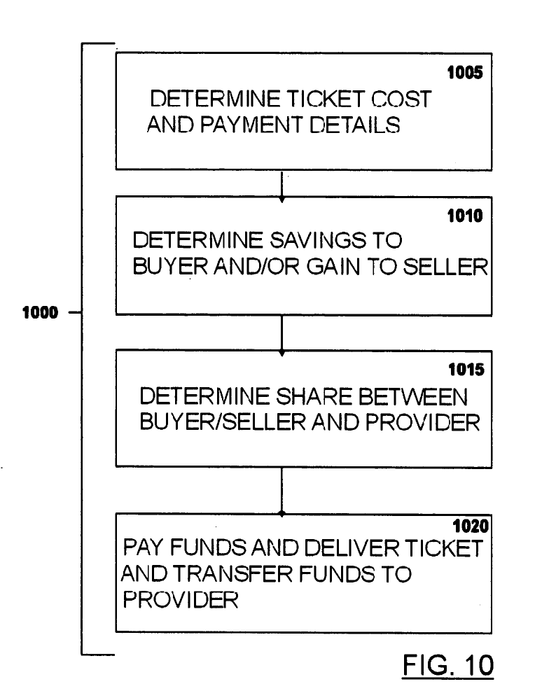

Turning now to FIG. 10, there is shown an alternative embodiment to the present disclosure shown as a method 1000. The method 1000 includes a number of processor-executable steps in order to perform the operations of the method 1000 and to share fees between a ticket seller, a ticket buyer, and a provider. In one embodiment, the share may be a predetermined percentage of the ticket sale. In another embodiment, the share may be in a range that includes one to four percent of the price of the ticket. In another embodiment, the share may be a percentage of an increase in the amount that the ticket has sold for attributed to the contribution of the provider. In yet another embodiment, the share may be a percentage in a reduction in a ticket that a purchaser has bought. In yet a further embodiment, the share may be paid by one party, two parties and an advertiser. For example, a ticket may be sold in the amount of 100 dollars and four percent of the purchase price may be paid to the provider, or 4.00 dollars, which may be added to the ticket price, or may come out of the sale price. In yet another embodiment, the ticket may have a face value of 500 dollars and may have sold for 1,000 dollars based on an increased demand. In this embodiment, the provider may be paid a predetermined percentage of the increase or 500 dollars above the face value of the ticket. In another example, the ticket may have a face value of 100 dollars but due to poor demand may have sold for 20 dollars. In this example, the provider may be paid a predetermined percentage of the savings, or a predetermined percentage of the 80 dollars. Various configurations are possible and within the scope of the present disclosure. Turning now to FIG. 10, there is shown the method 1000. The method 1000 is preferably operable with processor executable instructions and is stored on a computer readable medium. The method 1000 commences at block 1005. At block 1005, the processor may determine the ticket cost and the payment details including a buyer and a seller and may suggest one or more parameters of the exchange. At block 1010, the processor may determine a savings to the buyer and/or a gain to the seller, or may alternatively determine an increased cost to the buyer and a loss to the seller. For example, in some instances the ticket may be highly in demand and there may be little if any supply. In this case, the ticket may sell for a premium to the face value whereas the ticket cost may indicate a premium to the seller (profit) and a higher sale cost to the buyer. In block 1015, the share may be determined between the seller, buyer and provider. For example, one to four or more percent of the ticket cost to the provider. In block 1020, the funds are paid between the seller and the buyer via a second credit card provider and the instant provider. The ticket is delivered to the buyer from the seller or from an exchange.

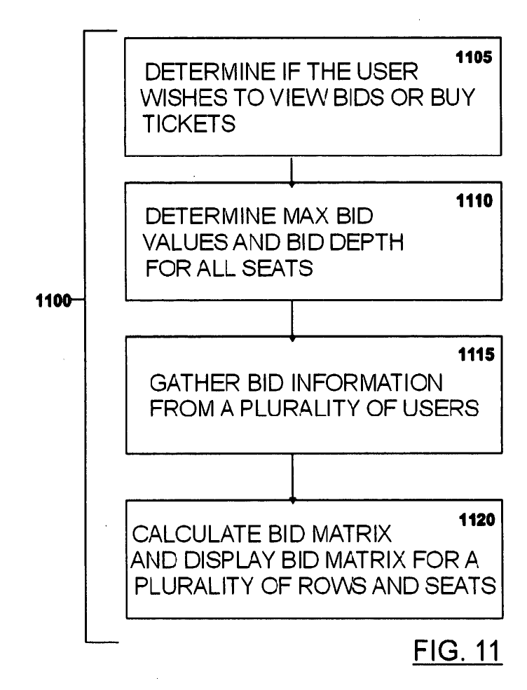

Turning now to FIG. 11, there is shown a method 1100 operable with a processor having processor executable instructions being stored on a recordable non-transitory storage medium. The method 1100 includes a number of processor executable steps operable in a number of blocks. In this embodiment, it may not be practical for all users depending on the venue to display bids for seats on a seat by seat basis since the amount of information may be too much for display purposes and may be confusing for the user. For example, a more appropriate display configuration may be to show bids for a larger subset of seats and then the provider may assign tickets within the respective subset at the suggested price. For example, in one embodiment, the subset may be a row or the like. In another embodiment, the subset may be a section of the stadium that is easily understood by a layman. For example, the subset may be generated or defined by the provider. In FIG. 11, the subset is the rows where a user may view and purchase tickets while not visualizing bids for each and every seat in the row but assuming that the row or the subset have all of the same price within reasonable limits. In block 1105, the processor may determine if the user wishes to purchase tickets or view bids. In block 1110, the processor may determine max bid values and bid depth for all seats within the venue as described above. In block 1115, the processor may gather bid information from a plurality of users. In block 1120, the processor may calculate the bid matrix for a plurality of rows and a plurality of seats of the subset that is desired. In this manner, the user may view bids only for a number of rows on a per seat basis. For example, upper tier, row 18 may be displayed as a max bid of 55.00 dollars and a minimum bid of 40.00 dollars per seat and a suggested bid of 52 dollars per seat. In this example, the user may then purchase a seat at the suggest bid of 52 dollars per seat and may receive any seats or consecutive seats within the row 18 without viewing a suggested different bid for every single row in row 18, which may be too cumbersome of a data set.

It should be understood, of course, that the foregoing relates to exemplary embodiments of the invention and that modifications may be made without departing from the spirit and scope of the invention as set forth in the following claims.

Furthermore, combinations of embodiments of the invention may be divided into specific functions and implemented on different individual computer processing devices and systems which may be interconnected to communicate and interact with each other. Dividing up the functionality of the invention between several different computers is meant to be covered within the scope of the invention.

While this invention has been particularly shown and described with references to a preferred embodiment thereof, it will be understood by those skilled in the art that is made therein without departing from the spirit and scope of the invention as defined by the following claims.

What is claimed is:

1. A method comprising:
obtaining data identifying a buyer of tickets for a venue;
obtaining data from the ticket buyer identifying at least one section within the venue;
obtaining data identifying (i) a maximum amount the ticket buyer would spend for a first ticket associated with a most favorable seat; and optionally (ii) a maximum amount the ticket buyer would spend for a second ticket associated with the least favorable seat;
providing an algorithm that receives the data of (i) the maximum amount the ticket buyer would spend for the first ticket associated with the most favorable seat; and
optionally (ii) the maximum amount the ticket buyer would spend for the second ticket associated with the least favorable seat, the algorithm generating a plurality of hypothetical acceptable tickets representative of the ticket buyer; and
generating a matrix comprising at least one of the ticket buyer's bids and extrapolated hypothetical bids to give other ticket buyers and ticket sellers' feedback to adjust bids and asks and optionally generating a transaction.

2. The method of claim 1, further comprising: providing the matrix to at least one of the ticket buyer or the ticket seller via a displayed image, and wherein the least and most favorable seats are within the same row or section.

3. The method of claim 2, further comprising the buyers or sellers viewing the matrix and the buyers or sellers comparing bid and asks with the matrix to determine an acceptable bid or ask amount other potential buyers or other potential sellers would purchase or sell.

4. The method of claim 3, further comprising accepting the bid or ask to form a binding transaction.

5. The method of claim 4, further comprising providing a binding purchase order and transferring funds and the tickets.

6. The method of claim 1, wherein the tickets are to a concert, music event, a live event, or sporting event.

7. The method of claim 5, further comprising transferring the funds electronically.

8. The method of claim 5, further comprising transferring the tickets electronically.

9. The method of claim 2, wherein the matrix is displayed with a map of the venue, the map comprising a graphical output of a seating chart with ticket locations, ticket prices, date of events, and event location.

10. The method of claim 1, wherein the data identifies the buyer by identification information, and by payment information.

11. The method of claim 1, further comprising identifying the ticket seller by identification information and by payment information.

12. The method of claim 5, further comprising transferring payment by a credit or debit provider, or payment provider.

13. The method of claim 1, further comprising generating asks using the algorithm.

14. The method of claim 1, further comprising generating a price gradient from the algorithm for other seats within the section, the gradient being prices between (i) the maximum amount the ticket buyer would spend for the first ticket associated with the most favorable seat within a section; and (ii) the maximum amount the ticket buyer would spend for the second ticket associated with the least favorable seat within a section; and further comprising receiving data from the ticket buyer associated with a third amount the ticket buyer would spend for a third ticket; and further comprising generating the map as a data image that corresponds to the venue, the data image having a section, row, and seats, and the matrix values being displayed within at least one of the section, row or seat.

15. The method of claim 14, further comprising selecting an acceptable seat for the event by selecting the seat associated with the data image.

16. A system comprising:
a first computer system comprising a processor, a memory, a bus and an internet connection, the first computing system being accessed by a first entity;
a second computer system comprising a processor, a memory, a bus, and an internet connection, the second computing system being accessed by a second entity;
obtaining data identifying the first entity, the first entity representing a first commercial transaction participant;
obtaining data identifying an amount the first entity would be willing to bid for a commercial transaction;
using an algorithm to generate a plurality of hypothetical acceptable bids that the first entity would likely offer, the hypothetical acceptable bids being generated by at least (i) the algorithm and (ii) the data identifying the amount the first entity would be willing to bid;
generating a matrix regarding the bids and the plurality of hypothetical acceptable bids; and
permitting the second entity to view the matrix.

17. The system of claim 16, further comprising displaying the matrix as a graphical output to the second entity; and wherein the second entity accesses the matrix to use the matrix as an index, wherein the index can permit the second entity to determine an acceptable amount to sell a ticket; and wherein the second entity accesses the matrix and uses the matrix to set a price for an item, the second entity posting the item for sale;
and further comprising a buyer or third entity of the commercial transaction that purchases from the first entity or the second entity; and wherein the commercial transaction involves goods, services, tickets, or data.

18. A method comprising:
obtaining data identifying the first entity, the first entity representing a first commercial transaction participant;
obtaining data identifying an amount the first entity would be willing to bid for a commercial transaction;
using an algorithm to generate a plurality of hypothetical acceptable bids that the first entity would likely offer, the hypothetical acceptable bids being generated by at least (i) the algorithm and (ii) the data identifying the amount the first entity would be willing to bid and
generating a matrix regarding the plurality of hypothetical acceptable bids.

19. A computer program product, comprising a computer usable medium having a computer readable program code embodied therein, said computer readable program code adapted to be executed to implement a method, the method comprising:
obtaining data identifying a buyer of tickets for a venue;
obtaining data from the ticket buyer identifying at least one section within the venue;
obtaining data identifying (i) a maximum amount the ticket buyer would spend for a first ticket associated with a most favorable seat optionally within the section; and optionally (ii) a maximum amount the ticket buyer would spend for a second ticket associated with the least favorable seat with the section;
providing an algorithm that receives the data of (i) the maximum amount the ticket buyer would spend for the first ticket associated with the most favorable seat within the section; and optionally (ii) the maximum amount the ticket buyer would spend for the second ticket associated with the least favorable seat with the section, and (iii) data from other bidders; and
generating a matrix to give other ticket buyers and tickets sellers' feedback to adjust bids and asks and executing a transaction.

20. A computer program product, comprising a computer usable medium having a computer readable program code embodied therein, said computer readable program code adapted to be executed to implement a method, the method comprising:
obtaining data identifying a seller of tickets for a venue;
obtaining data regarding a ticket for sale from the ticket seller;
obtaining data identifying (i) a maximum amount a ticket buyer would spend for a first ticket associated with a most favorable seat; and optionally (ii) a maximum amount the ticket buyer would spend for a second ticket associated with the least favorable seat;
providing an algorithm that receives the data of (i) the maximum amount the ticket buyer would spend for the first ticket associated with the most favorable seat within the section; and optionally (ii) the maximum amount the ticket buyer would spend for the second ticket associated with the least favorable seat, and (iii) data from other bidders; and
generating a matrix to the ticket sellers, the matrix providing feedback, the ticket seller comparing an ask with the matrix to determine if the ask price will be met; and
forming a transaction

21. A method for selling tickets in a primary ticket market comprising:
obtaining data identifying the first entity, the first entity representing a first commercial transaction participant;
obtaining data identifying an amount the first entity would be willing to bid for a commercial transaction;
generating a plurality of hypothetical acceptable bids that the first entity would offer, the hypothetical acceptable bids being generated by at least (i) the data identifying the amount the first entity would be willing to bid and (ii) bids from other users;
generating a matrix regarding the plurality of hypothetical acceptable bids; and
generating an offer to sell tickets from the primary ticket provider based at least in part from the matrix.

22. The method of claim 21, further comprising displaying the matrix to the commercial transaction participant prior to requesting a bid from the commercial transaction participant; and further comprising revising the offer based on the matrix.
